(19) United States
(12) Patent Application Publication
(10) Pub. No.: US 2010/0215820 A1
(43) Pub. Date: Aug. 26, 2010

(54) Refining of edible oil

(76) Inventor: Aicardo Roa-Espinosa, Madison, WI (US)

Correspondence Address: STEVEN H GREENFIELD, 4649 SEMINOLE TRAIL, GREEN BAY, WI, 54313, US

(21) Appl. No.: 12/390,570

(22) Filed: Feb. 23, 2009

(51) Int. Cl. A23D 7/04

(52) U.S. Cl. 426/417

(57) ABSTRACT

A process for refining crude edible oil is disclosed. The present invention comprises the treating the crude oil with caustic and an agglomerating polymer and precipitating an impurities layer. The impurities layer is then mechanically separated from the refined oil. The process may be run in a batch or semi-continuous mode. This process greatly simplifies the prior and current art processes for refining edible oil.

### BACKGROUND OF THE INVENTION

The present invention generally relates to a method for refining and removing solids and impurities from crude edible oils. Edible oil sources include but are not limited to oils originating from fruits and vegetables such as cottonseed oil, olive oil, cassava oil, fruit oil, neem oil, rapeseed oil, canola oil, soybean oil, vegetable oil, grape oil, corn oil, sunflower oil, palm oil, peanut oil and coconut oil. Edible oil sources may also include waste frying or cooking oil from homes and restaurants. More specifically, the present invention relates to a method for the agglomeration, precipitation and removal of the impurities from edible oil. More specifically yet, the present invention relates to a method for the agglomeration, precipitation and removal of a natural toxin, gossypol, from cottonseed oil.

Contaminants, solids and impurities found in these oils include gossypol, monoglycerides, diglycerides, free fatty acids, and phospholipids. They represent a wide range of particle sizes, colors, contents and toxicity levels. Cottonseed oil for example has a high content of gossypol.

An example of a current process for oil refining is provided in U.S. Pat. No. 5,310,487. A vegetable oil such as soybean oil, rapeseed oil, cottonseed oil, safflower oil, corn oil, sunflower oil and the like is extracted with an organic solvent such as hexane to obtain micella comprising the solvent and dissolved impurities. Following the extraction, the solvent is evaporated to obtain a crude glyceride oil composition. This crude glyceride oil usually comprises from 0.5-10% by weight of impurities including phospholipids such as lecithin as its primary ingredient, waxes such as higher alcohols, organic sulfur compounds, peptides, free fatty acids, hydrocarbons, carbohydrates, dye compounds, metals and the like. These impurities cause polymerization or decomposition during the processing sequence or in use or upon heating and tend to result in oil coloration or unpleasant odors with the concomitant acceleration of oxidation or deterioration. Accordingly, the next step in the prior art process involves degumming to remove these impurities. Degumming involves adding water to the oil to hydrate the gum material which is primarily composed of phospholipids which may be further purified to yield lecithin. Phosphoric acid may also be used to enhance the degumming operation. The degummed oil is then subjected to chemical (caustic) refining, typically with sodium hydroxide, which reacts with free fatty acids to produce soaps which are acidified to remove residual phospholipids. Following, pigments and destabilizing peroxide-like compounds are absorbed by acid activated bleaching clays and, finally, the oil is heated under vacuum with steam sparging to strip trace amounts of free fatty acids, aldehydes, ketones and other volatile compounds.

This process requires multiple steps and is both energy and equipment intensive. Thus there is a need to simplify the process to increase its speed and reduce cost.

### SUMMARY OF THE PRESENT INVENTION

The method of the present invention for refining a crude edible oil source comprises providing a crude edible oil having a composition containing impurities; determining the composition of the crude edible oil from appropriate tests; determining best conditions for the process based on results from the tests for the composition of the crude edible oil; heating the crude edible oil source to a predetermined caustic treatment temperature; adding a predetermined amount of caustic solution to the crude edible oil source and mixing the crude edible oil source with the caustic solution for a predetermined time period to form a well dispersed blend of crude edible oil source and caustic solution; heating the blend of crude edible oil source and caustic solution to a predetermined polymer treatment temperature; adding a predetermined amount of an agglomerating polymer to the blend of crude edible oil source and caustic solution and mixing the blend of the crude edible oil source and caustic solution with the agglomerating polymer for a predetermined time period to achieve a well dispersed blend of the crude edible oil source, the caustic solution and the agglomerating polymer; precipitating an impurities residue layer from a refined oil layer; and separating the impurities residue layer from the refined oil layer.

These and other features, aspects and advantages of the present invention will become better understood with reference to the following drawings, description and claims.

### BRIEF DESCRIPTION OF THE DRAWINGS

FIG. 1 is a generalized schematic of a conventional edible oil refining plant configuration currently employed in the art.

FIG. 2 is a flow chart of the steps for a conventional edible oil refining process.

FIG. 3 is a generalized schematic of the edible oil refining plant of the present invention.

FIG. 4 is a flow chart of the present invention process steps.

### DETAILED DESCRIPTION OF THE INVENTION

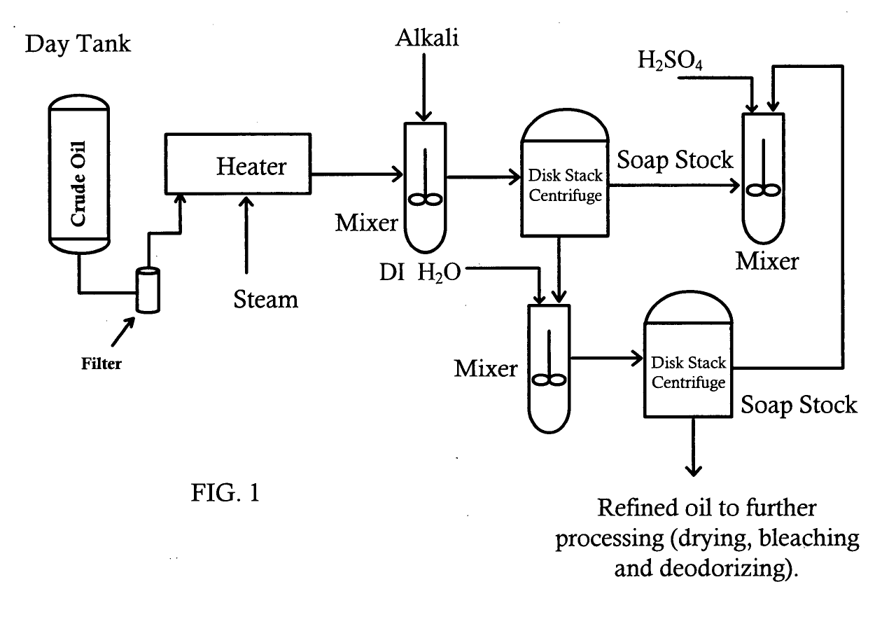

The crude edible oil source of the present invention may originate from any natural growth such as fruits, vegetables, and parts of trees and brush, and from waste frying and cooking oils. The crude edible oil source may also be a blend of multiple crude edible oil sources including blends of vegetable oils, fruit oils and waste cooking and frying oils. An embodiment of a prior and current art process for refining a crude edible oil source involves filtering and heating an edible crude oil source and mixing it with caustic in a high sheer mixer. Soap is removed by centrifuging in two stages by disk stack centrifuges. The soap is acidulated with sulfuric acid as shown in FIG. 1. Typically the oil exiting the second centrifuge is largely soap free. Further processing, including bleaching with acid activated bleaching clays and heating the oil under vacuum with steam, may be needed to achieve a sufficiently low impurities content in the refined oil.

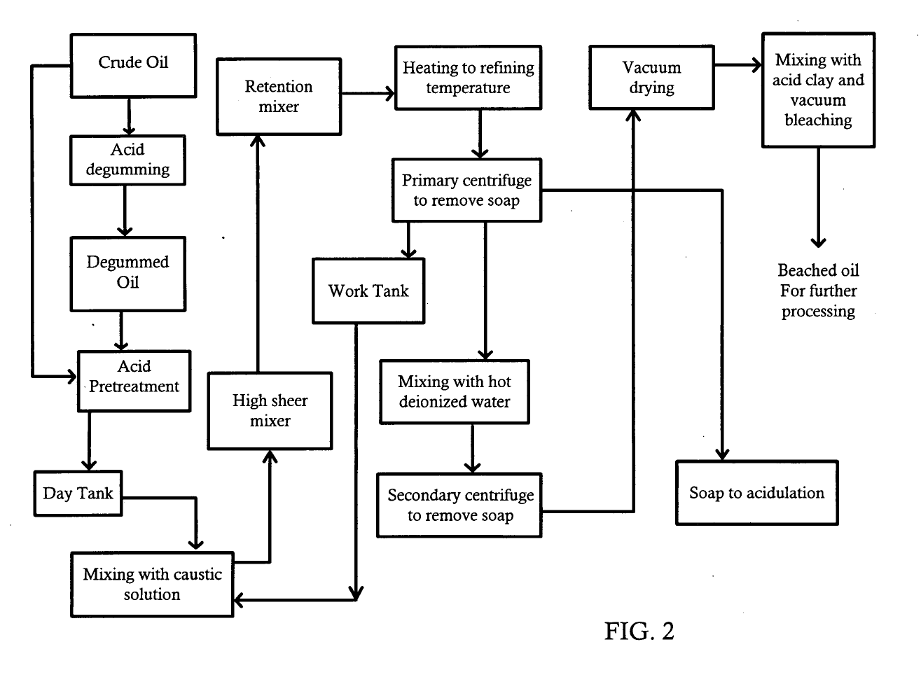

In another embodiment of a prior and current art process for refining edible oil shown in FIG. 2, crude oil is degummed by mixing with water and phosphoric acid. The phosphoric acid may be dispersed in the oil with a high sheer mist. The degummed oil may treated with a caustic solution, typically sodium hydroxide, and mixed with a high sheer mixer at temperatures in the range of about 32-42° C. The caustic treated oil may then pass through a set of retention mixers having top entering agitators and knife blades to maximize mixing under gentle conditions. The mixture may be retained in the retention mixers for about 4 to about 15 minutes depending on the oil being refined. The caustic treated oil may then be heated in a steam heater to a temperature between about 65° C. to about 73° C. and passed through a primary centrifuge for separating the oil from the soap. At this stage, the oil may be tested for percent free fatty acid content, phosphate content, and soap content and compared against targets (e.g., the free fatty acid less than 0.03%, phosphorus less than 3 ppm and soap content of less than 500 ppm). If the percent free fatty acid does not match or fall below the target, the oil may be collected from the primary centrifuge into a work tank and returned to the caustic reactor stage. If phosphorus and soap contents are above targets, a de-ionized water washing and secondary centrifuging step may be employed. Excess soap may be acidulated with sulfuric acid. Depending on the specification, the centrifuged oil may further undergo vacuum drying, and bleaching with acid clay. These processes may be carried out in either batch or semi-continuous fashions.

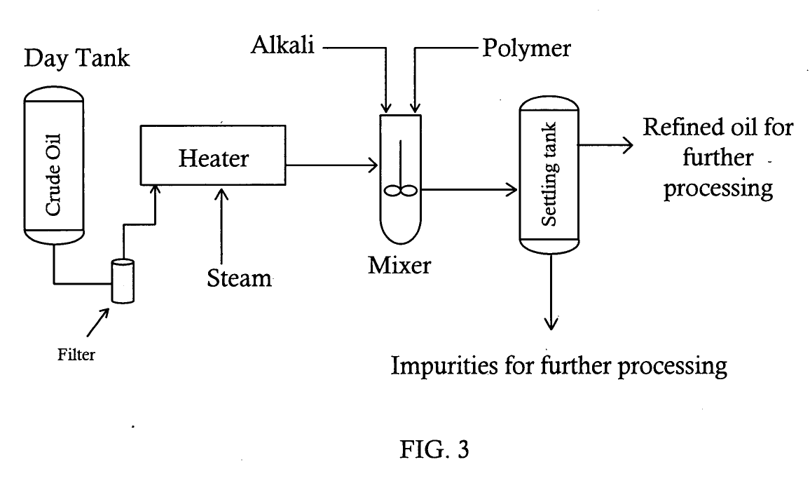

The process of the present invention illustrated in FIG. 3 may represent a significant simplification compared to the current art processes. With this process, the steps following the caustic treatment step are replaced with three simple steps: a treatment step using an agglomerating polymer, a precipitation step and a phase separation step. The eliminated steps may include any or all of the steps of heating the caustic treated oil, the primary and secondary centrifuging, soap acidulation, and the post centrifuge separation processes such as vacuum drying and acid clay bleaching. The edible oil refining process of the present invention may require fewer steps and provide for significant equipment, material and energy savings compared to the conventional oil refining processes.

In one embodiment of the present invention, the first step of the process comprises determining the content and composition of the impurities in the crude oil source in order to determine the optimum refining process steps and treatment conditions. The composition of the impurities may contain solids, gossypol, monoglycerides, diglycerides, Free Fatty Acids (FFA), phosphorus, chlorophyll, waxes, organic sulphur compounds, phospholipids, lecithin, dyes, and trace metals. The treatment conditions are determined based on this information. Oils that contain relatively high levels of impurities may require higher temperatures, longer mixing dwell times and/or higher levels of treatment chemicals to achieve the target purity levels compared to oils that contain relatively low levels of impurities. The test may also determine whether insoluble solids are present. If insoluble solids are present, filtering these solids will likely be the next step. The third step in the process may comprise heating the crude edible oil source to a temperature between about 25° C. to about 35° C. depending on the crude oil source and the composition and content level of the impurities present in the oil. In the fourth step, the heated crude oil source is treated with a caustic solution which may be sodium hydroxide, NaOH, or potassium hydroxide, KOH. The sodium hydroxide or potassium hydroxide may be blended with the crude edible oil source at between about 0.5% to about 2% by weight of the crude edible oil source depending on the composition of the oil source. The caustic treated oil must be mixed vigorously to achieve a well blended mixture and to insure intimate contact between the caustic and the impurities. A high sheer mixer should be used and typical mixing dwell times may range between about 10 minutes to about 30 minutes. The concentration of the caustic may range from about 25% to about 40%. For optimum process effectiveness and efficiency, it is best to use a caustic having a purity of at least 98%. The fifth step in the process may be heating the mixture to a predetermined temperature of between about 40° C. and about 70° C. depending on the composition of the crude edible oil source. Typically, the optimum temperature range is between about 50° C. to about 55° C.

In one embodiment of the present invention, the sixth step of the process is treating the mixture of crude edible oil source and caustic with an agglomerating polymer at a rate of about 1 ppm to about 25 ppm based on the weight of the crude edible oil source. The treatment includes blending the agglomerating polymer with the mixture of crude edible oil source and caustic and mixing for a time ranging between about 2 minutes and about 15 minutes. The seventh step includes transferring the resulting mixture into a holding tank and allowing it to settle for a time period between about 10 minutes to about 30 minutes. Two fluid layers typically separate into two phases in the holding tank during this settling period: a dark layer containing the impurities precipitates to the bottom of the holding tank and a bright yellow refined oil layer remains at the top. The impurities layer contains nearly all the impurities initially contained in the crude edible oil source including gossypol, monoglycerides, diglycerides, free fatty acids, waxes, phosphorus, chlorophyll, organic sulphur compounds, phospholipids, lecithin, dyes, and trace metals leaving only trace amounts of these impurities in the refined oil layer. Nearly all the soap generated by the caustic treatment of the edible crude oil source, is likewise contained in the impurities layer leaving only trace amount of the soap in the refined oil layer.

Experimental data indicate that the precipitation of the impurities layer has a characteristic percent completion as a function of time, as judged by the change in the refined oil color. About 50% of the separation is completed in about 10 minutes and nearly 100% of the separation is completed in about 30 minutes.

In the eight step of the process, the layer containing the impurities is mechanically separated from the refined oil layer. The mechanical separation of the impurities layer from the refined oil layer may be accomplished by techniques known in the art for separating two layers having different densities including but not limited to decanting, draining by gravity, and inserting a physical barrier such as a gate valve at the interface between the layers to achieve a more complete separation of the layer and prevent intermixing.

The relatively short duration times of the various process steps may make it possible to run the process in a batch mode or in a semi-continuous mode in which duplicate unit operations are set up to handle any bottlenecks in the process.

If needed, the refined oil layer may undergo further treatments such as centrifuging, vacuum drying and acid clay bleaching. The impurities layer may likewise undergo further treatments including extraction of beneficial components that may have uses such as in animal feed. A final step in the purification process to remove trace impurities or trace odors may be passing the refined oil through a resin exchange column. An example of such an exchange column currently known in the art is manufactured by Purolite®.

In another embodiment of the present invention, the caustic and the polymer are mixed together to form the treatment solution for the edible crude oil source.

The agglomeration and precipitation of the impurities layer to achieve separation of the impurities layer and the refined oil layer is accomplished in the process of the present invention by the mechanisms of coagulation and flocculation. Coagulation is the destabilization of colloids by neutralizing the forces that keep them apart. Cationic coagulants provide positive electric charges to reduce the negative charge, or zeta potential, of the colloidal particles which the impurities typically comprise. As a result, the particles collide to form larger particles referred to as flocs. Flocculation is the action of polymers to form bridges between the floes and bind the particles into larger agglomerates or clumps. Bridging occurs when segments of the polymer chain adsorb on different particles and help particles aggregate. An anionic flocculant will react against a positively charged suspension, adsorbing on the particles and causing destabilization either by bridging or charge neutralization. In order to effectively flocculate a colloidal suspension, a very high molecular weight polymer, typically greater than 1 million is required. It is to be understood that effective coagulants or flocculants could perform well in and of themselves, however, when combined there is an enhanced synergistic effect. The floes formed by coagulation and flocculation of the impurities typically have densities higher than the oil in which the colloidal particles are suspended and precipitate out of the oil. In one embodiment of this invention, a coagulant is used to agglomerate and precipitate the impurities layer. In another embodiment of the present invention, a flocculant is used to agglomerate and precipitate the impurities layer. In yet another embodiment of the present invention, one or more coagulant and one or more flocculant are combined to agglomerate and precipitate the impurities layer. A variety of coagulants and flocculants are known in the art. These include inorganic coagulants such as aluminium sulfate (alum), calcium oxide, and magnesium oxide, and organic coagulant polymers including linear polyamines such as Polydimethylamine-epichlorohydrin, and branched polyamines such as Polydicyandiamide, Diallyldimethyl-Ammonium Chloride (DADMAC) and Poly-Diallyldimethyl-Ammonium Chloride (Poly-DADMAC). Known flocculants include such polymers as cationic and anionic polyacrylamides.

Gossypol is an impurity component in cottonseed oil that is a toxin in its pure form and thus needs to be removed in the refining process. Gossypol is neutralized with caustic in the fourth step of the process of the present invention as shown below:

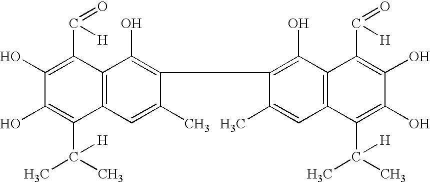

Gossypol: (2,2′-bis-(Formyl-1,6,7-trihydroxy-5-isopropyl-3-methylnaphthalene) having the general formula of C₃₀H₃₀O₈.

The reaction of sodium hydroxide and gossypol yields the following:

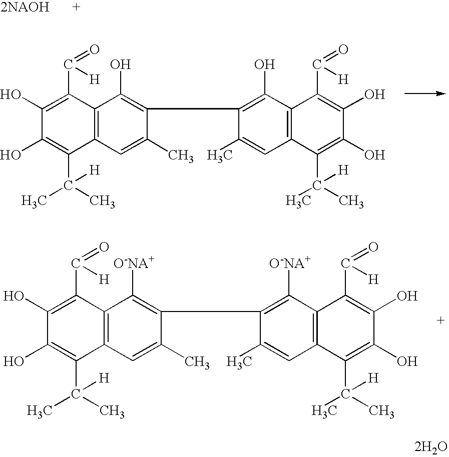

The displacement of the hydrogen atoms in the OH groups by the sodium and the creation of the polar groups in the gossypol facilitate the agglomeration and precipitation of these molecules by a coagulating or a flocculating mechanism.

In one embodiment of the present invention the agglomerating polymer is Polydicyandiamide (DMD), a branched polyamine acting as a coagulant. Polydicyandiamide is obtained from the reaction of Dicyandiamide monomer and formaldehyde as shown below:

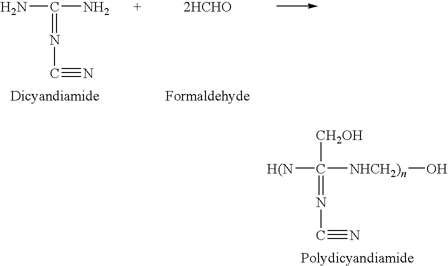

In this embodiment, the molecular weight of the Polydicyandiamide is between about 3000 and 150,000 and it has a high cationic charge level.

In another embodiment of the present invention, the agglomerating polymer is Polydimethylamine-epichlorohydrin which is a linear cationic polyamine acting as a coagulant obtained from the reaction of Dimethylamine and Epichlorohydrin:

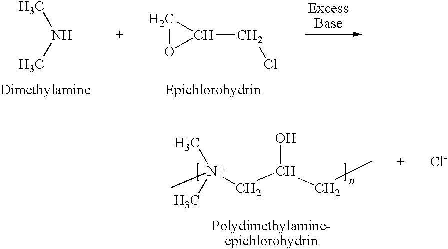

The molecular weight of the Polydimethylamine-epichlorohydrin is ideally between about 10,000 and 1,000,000.

In yet another embodiment of the present invention, the agglomerating polymer is Diallyldimethyl-Ammonium Chloride (DADMAC), or Poly-Diallyldimethyl-Ammonium Chloride (Poly-DADMAC), a cationic branched polyamine acting as a coagulant that is a product of the reaction between dimethylamine and allyl chloride. Diallyldimethyl-Ammonium Chloride and Poly-Diallyldimethyl-Ammonium Chloride are produced by the same reaction shown below, but Diallyldimethyl-Ammonium Chloride is made under conditions that inhibit polymerization while the Poly-Diallyldimethyl-Ammonium Chloride is made under conditions that promote polymerization. The molecular weight of the Poly-Diallyldimethyl-Ammonium Chloride is ideally between about 10,000 and 1,000,000.

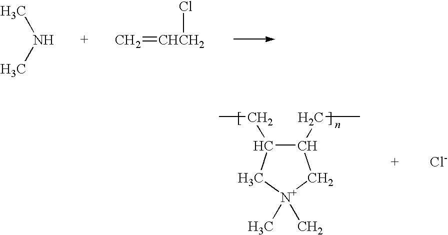

In yet another embodiment of the present invention, the agglomerating polymer is an anionic polyacrylamide. More specifically it is Sodium Acrylate Acrylamide copolymer acting as a flocculant resulting from the reaction between an Acrylamide monomer and an Acrylic Acid monomer as shown below. This anionic polyacrylamide of the present invention preferably has a charge density between about 25% and 75% and a molecular weight of between 8 million and 28 million:

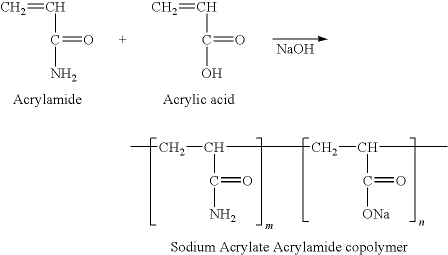

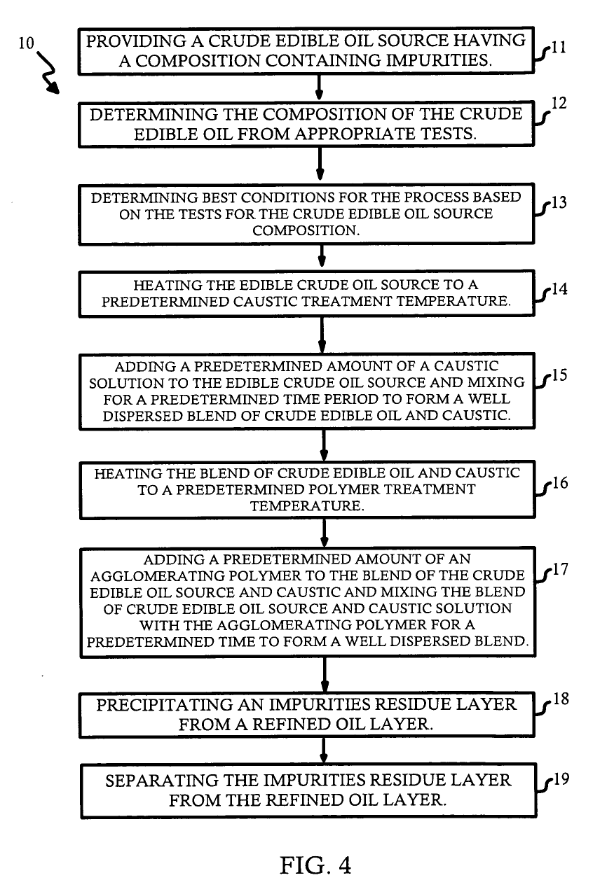

Referring to FIG. 4, there is shown a flow chart depicting the process 10 of the present invention. Step 11 includes providing a crude edible oil source having a composition containing impurities. Step 12 includes determining the composition of the crude edible oil from appropriate tests. Step 13 includes determining best conditions for the process based on the tests for the crude edible oil source composition. Step 14 includes heating the crude edible oil source to a predetermined caustic treatment temperature. Step 15 includes adding a predetermined amount of caustic solution and to the edible oil source and mixing for a predetermined time period to form a well dispersed blend of crude edible oil and caustic. Step 16 includes heating the blend of crude edible oil and caustic to a predetermined polymer treatment temperature. Step 17 includes adding a predetermined amount of an agglomerating polymer to the blend of the crude edible oil source and caustic and mixing the blend of crude edible oil source and caustic solution with the agglomerated polymer for a predetermined tome to form a well dispersed blend. Step 18 includes precipitating an impurities residue layer from a refined oil layer. Step 19 includes separating the impurities residue layer from the refined oil layer.

### EXAMPLES

The following examples relate to laboratory simulations of the process of the present invention. The crude oil source was cottonseed oil. The largest component of the impurities contained in cottonseed oil is gossypol. The crude oil was dark in appearance. In each case, a 300 gram sample of the crude oil source was treated in a beaker with sodium hydroxide solution having a concentration of 25% and a purity of 98%. Sodium hydroxide treatment amounts, temperature and mixing retention times varied. The sodium hydroxide treated crude oil was then treated with different agglomerating polymers and polymer amounts at varying temperatures and at varying mixing retention times. The impurities content in the crude cottonseed oil source was determined from spectrophotometry tests. The results indicated that the crude cottonseed oil sample comprised of about 1.2% phospholipids, 425 mls/gram of phosphorus, and 2.4% free fatty acids. Following the polymer treatment, the contents were allowed to settle. A dark colored impurities layer precipitated to the bottom of the beaker leaving a light yellow colored oil layer at the top of the beaker. In Examples 1, 2 and 3, the time of precipitation and separation of the dark layer from the refined oil later showed a relatively slow progression from 0-10 minutes, and a fast progression from 10-20 minutes at which time about 80-90% of the separation was completed. At 30 minutes, the separation was about 100% completed. Spectrophotometry tests done on the refined oil layer indicated that the percent free fatty acid ranged from 0.06% to 0. 13%. Color readings ranged from 9.7R to 10.7R, and 70Y. Soap was undetectable. These runs were repeated for canola oil. The % FFA of the treated canola oils ranged from 0.04% to 0.06%. A typical percent separation completion plot as a function of time is shown below:

### Example 1

### Sodium Hydroxide Mixing Conditions

Concentration of sodium hydroxide: 25%
Amount added: 10 mls (about 0.8% by weight of the crude oil sample)
Mixing temperature: 30° C.
Mixing time: 22 minutes

### Polymer Addition and Mixing

Polymer: Polydimethylamine-epichlorohydrin
Amount added: 10 ppm by weight of the crude cottonseed oil
Mixing temperature: 50° C.
Mixing time: 8 minutes

### Example 2

### Sodium Hydroxide Mixing Conditions

Concentration of sodium hydroxide: 25%
Amount added: 8 mls (about 0.7% by weight of the crude oil sample)
Mixing temperature: 35° C.
Mixing time: 20 minutes

### Polymer Addition and Mixing

Polymer: poly-diallyldimethyl-ammonium chloride
Amount added: 10 ppm by weight of the crude cottonseed oil
Mixing temperature: 50° C.
Mixing time: 8 minutes

### Example 3

### Sodium Hydroxide Mixing Conditions

Concentration of sodium hydroxide: 25%
Amount added: 14 mls (about 1.2% by weight of the crude oil sample)
Mixing temperature: 35° C.
Mixing time: 20 minutes

### Polymer Addition and Mixing

Polymer: 1:1 mixture of Polydimethylamine-epichlorohydrin and poly-diallyldimethyl-ammonium chloride
Amount added: 10 ppm of each polymer by weight of the crude cottonseed oil
Mixing temperature: 50° C.
Mixing time: 8 minutes

### Example 4

In this example, nearly 100% of the separation was completed in about 15 minutes.

### Sodium Hydroxide Mixing Conditions

Concentration of sodium hydroxide: 25%
Amount added: 8 mls
Mixing temperature: 35° C.
Mixing time: 20 minutes

### Polymer Addition and Mixing

Polymer: a mixture of Sodium acrylate acrylamide copolymer and Polydimethylamine-epichlorohydrin.
Amount added: 5 ppm by weight of the crude cottonseed oil of Sodium acrylate acrylamide copolymer and 10 ppm of Polydimethylamine-epichlorohydrin.
Mixing temperature: 45° C.
Mixing time: 5 minutes

I claim:

1. A process of refining a crude edible oil source comprising:
providing a crude edible oil having a composition containing impurities;
determining the composition of said crude edible oil from appropriate tests;
determining best conditions for the process based on results from said tests for the composition of said crude edible oil;
heating said crude edible oil source to a predetermined caustic treatment temperature;
adding a predetermined amount of a caustic solution to said crude edible oil source and mixing said crude edible oil source with the caustic solution for a predetermined time period to form a well dispersed blend of crude edible oil source and caustic solution;
heating said blend of crude edible oil source and caustic solution to a predetermined polymer treatment temperature;
adding a predetermined amount of an agglomerating polymer to the blend of crude edible oil source and caustic solution and mixing the blend of the crude edible oil source and caustic solution with the agglomerating polymer for a predetermined time period to achieve a well dispersed blend of the crude edible oil source, caustic solution and agglomerating polymer;
precipitating an impurities residue layer from a refined oil layer; and
separating the impurities residue layer from the refined oil layer to produce a refined oil stream and an impurities stream.

2. The process of claim 1, wherein the agglomerating polymer is added at a rate of about 1 to about 25 parts per million by weight of the crude edible oil source.

3. The process of claim 2, wherein the agglomerating polymer is added at a rate of about 8 to about 12 parts per million by weight of the crude edible oil source.

4. The process of claim 1, wherein the agglomerating polymer is Polydimethylamine-epichlorohydrin.

5. The process of claim 1, wherein the agglomerating polymer is Polydicyandiamide.

6. The process of claim 1, wherein the agglomerating polymer is Diallyldimethyl-Ammonium Chloride.

7. The process of claim 1, wherein the agglomerating polymer is Poly-Diallyldimethyl-Ammonium Chloride.

8. The process of claim 1, wherein the agglomerating polymer is an anionic polyacrylamide.

9. The process of claim 7, wherein the agglomerating polymer is Sodium Acrylate Acrylamide copolymer.

10. The process of claim 1, wherein the predetermined time period to form a well dispersed blend of crude edible oil source and caustic solution is at least about 10 minutes.

11. The process of claim 1, wherein the caustic solution is sodium hydroxide having a purity of at least about 98%.

12. The process of claim 1, wherein the predetermined time period to achieve a well dispersed blend of the crude edible oil source, caustic solution and agglomerating polymer is in a range from about 2 minutes to about 15 minutes.

13. The process of claim 1 further comprising:
filtering the crude edible oil source to remove solids; and
pre-treating the crude edible oil source with an acid prior to heating said crude edible oil source to a predetermined caustic treatment temperature.

14. The process of claim 1 further comprising:
centrifuging said oil layer; and
passing said oil layer through a resin exchange column.

15. The process of claim 14 further comprising:
treating the refined oil layer with an acid activated clay; and
heating the refined oil layer under vacuum.

16. The process of claim 14 further comprising:
filtering the impurities residue layer to form a filtered impurities residue layer;
centrifuging said filtered impurities residue layer to separate out a centrifuged layer; and
passing said centrifuged layer through a resin exchange column.

17. The process of claim 1, wherein the predetermined caustic treatment temperature is between about 25° C. to about 35° C.

18. The process of claim 1, wherein the predetermined polymer treatment temperature is between about 40° C. to about 70° C.

19. The process of claim 18, wherein the predetermined polymer treatment temperature is between about 50° C. to about 55° C.

20. The process of claim 1 wherein said process is run in a batch mode.

21. The process of claim 1 wherein said process is run in a semi-continuous mode.

22. The process of claim 1 wherein the agglomerating polymer comprises a blend of two or more agglomerating polymers.

23. The process of claim 1 wherein said crude edible oil source is treated with a mixture of agglomerating polymer and caustic solution.
